(19) United States
(12) Patent Application Publication
(10) Pub. No.: US 2005/0209840 A1
(43) Pub. Date: Sep. 22, 2005

(54) Method and apparatus for functional language temporal extensions, dynamic modeling, and verification in a system-level simulation environment

(76) Inventors: Mikhail Baklashov, Mountain View, CA (US); Laung-Terng (L.T.) Wang, Sunnyvale, CA (US)

Correspondence Address: Jim Zegeer, 801 N. Pitt Street, #108, Alexandria, VA, 22314, US

(21) Appl. No.: 11/029,345

(22) Filed: Jan. 6, 2005

Related U.S. Application Data
(60) Provisional application No. 60/535,100, filed on Jan. 9, 2004.

(51) Int. Cl. G06F 17/50

(52) U.S. Cl. 703/22

(57) ABSTRACT

A method and apparatus for functional simulation of a system 104 in a system-level simulation and verification environment using a functional language 100 derived from a selected Scheme Language standard, and a simulator 105 for simulating verification functions 101 and model functions 102 expressed in the functional language 100. The functional language 100 has syntax extensions expressed as dynamic “always @” and “@” blocks, and all other event expressions which are similar to Verilog and other RTL (Register-Transfer Level) HDL (Hardware Description Language) temporal syntax constructs. A composer 103 is further used to connect verification functions 101 with model functions 102. Model functions 102, represented as mutable state functional objects along with selected test, monitor, checker and user-defined functions, sample reactive responses and ensure concurrent drive of abstracted signals for the simulator 105. The simulator 105 can function as a formal verifier to formally verify the model functions 102, or a synthesizer to transform programs written in a restricted subset of the functional language 100 into an internal control and data flow format or any synthesis-ready language. A system-level modeling and simulation environment enhanced with a graphical user interface facilitates the usage of the functional language 100.

### RELATED APPLICATION DATA

This application claims the benefit of U.S. Provisional Application No. 60/535,100 filed Jan. 9, 2004, which is hereby incorporated by reference.

### FIELD OF THE INVENTION

The present invention generally relates to the field of testing dynamic models in electronic design and other complex temporal reactive systems. Specifically, the present invention relates to a method and apparatus for dynamic functional programming language extensions and environment for design and verification of such systems.

### BACKGROUND OF THE INVENTION

With advanced computer technology, large systems are often built to fulfill complicated tasks. As the systems get larger, they become less reliable. Testing has become an indispensable part of system design and analysis; however, it has proved to be a formidable task for complex systems. Testing exists in a variety of forms in different areas of science and technology. The task is: we have a specification of a system design and we want to test if a given implementation conforms to the specification based on the observed system input and output behavior.

To model and verify those types of behaviors, special requirements are needed for the environment in which one may simulate system behavioral functions. The environment must comprise the means to abstract the model and test behaviors at very high levels, enough to overcome complexly arranged system elements and their interrelations. The environment must also have the means to express concurrent behaviors and account for complex temporal dependencies occurring among the system functions.

A number of programming languages have been introduced to simulate and test system designs. Two main Hardware Description Languages (HDLs), Verilog and VHDL, are in use today for hardware verification. The languages are well suited for design descriptions at the register-transfer level (RTL) that gets compiled into gate level representations during a subsequent synthesis stage. However, those languages have significant deficiencies for hardware verification. Some notions, for example, embedded or other large memory models, cannot be expressed in HDLs for both, design and verification.

The current HDLs are suitable for creating hardware models comprising primarily the static concurrent processes that simulate individual parts. Meanwhile, HDLs provide a level of abstraction that is not enough to develop useful verification environments. The lack of concurrent flow control devices largely limits the use of multiple threads to simulate a real verification environment. To account for missing functionalities, implementors had turned to programming language interfaces that provided links to C, C++ and scripting languages, but even these failed to attain a needed amount of popularity because these other languages have no concept of timing, or concurrency.

To compensate for these shortcomings, a few Hardware Verification Languages (HVLs), such as Vera, SystemC, SystemVerilog, and “e”, have been developed, specifically for hardware verification. The unraveling of the nature and misuse of such languages leads the way in some measure to anticipate the new language. Despite the fact that existing HVLs provide additional functionalities for hardware verification that HDLs lack, the languages are not advancing significantly in the level of abstraction and provide only the minimal abstraction level for developing verification environments. These prior-art HVL implementations are either extensions of low-level C with features of scripting languages or a C++ library wrapped into a “new language”.

By no means, a new language neither should come before any abstracted knowledge, nor it must be used for creating or explaining such knowledge. Programming languages should be designed not by piling features on top of features, but by removing the weaknesses and restrictions that make additional features appear necessary. An abstraction, in terms of English-like specification or in any other form, always comes before the language and, therefore, the new language must only allow for easiest abstraction implementation.

Therefore, there is a need for a very high-level language and productive tools that can enable fewer, less experienced programmers to develop and verify new systems in less time and with better quality. When building and verifying complex systems, all attention should be paid to the design and verification requirements and not to the language that is being used. Thus, the verification language has to be as much transparent for engineers as possible; still it has to be powerful enough to simply emulate existing testbench flows and methodologies. The language should be able to express concurrent behaviors and account for complex temporal dependencies occurring among the system functions.

### SUMMARY OF THE INVENTION

Accordingly, the invention provides a method and apparatus to facilitate functional verification of complex reactive systems, such as system-on-a-chip (SoC) designs, multiprocessors and embedded systems with software and hardware modules. The invention includes a functional language, SL, with specific extensions to model functional, temporal behavior of the modules along with their interactions and a functional language based environment, MetaSL, for creating intelligent testbenches, functional virtual prototypes for large systems, and generating functional executable specifications.

The MetaSL system environment comprises the following major components. A functional language, SL, to write models and tests according to functional design specification represented as English-like detailed description of behavioral functions. RTL HDL and other transaction-level language behavioral models can also be used in the environment along with the invention SL language. An interface to create links inside the language environment as well as to other language models and proprietary RTL simulators. A cycle-based simulator to simulate stand-alone models in the language environment. A simulator component ensures the invention language to be a self-contained language along with reusing test programs when linking to proprietary RTL simulators. During such linking, reference golden models written in the invention language can be used for checker functions. A special user-defined conformer program needs writing to analyze and compare simulation data from the simulator component and the RTL simulator. In case both data conform to each other, the program flags a valid result. Further modifications or corrections in testbench, RTL model or design specification are required otherwise.

The invention SL language is built around the existing IEEE-1990 Scheme standard. Scheme is a well designed language that has been adopted as an alternative to other programming languages. The environment is interactive, allowing for incremental development and testing parts of user programs. Programs written in the language can also be compiled for Intellectual Property (IP) protection and to make programs run fast. The invention language, SL, is an IEEE-based functional language with temporal constructs similar to those in Verilog and other HDL languages, (always @ (posedge clka) . . . ), (@ (negedge clkb)), etc. It is a very high abstraction level language with all of the powerful functions defined in the standard. The language has additional functions for defining interface signals, connecting the interfaces, and a function to define multiple clocks and their parameters, such as skew, positive phase, negative phase, and initial value. Users may control and observe interface signals concurrently from different threads. When writing testbenches, users may synchronize their tests to different clocks. There are primitive simulation control functions like ($simulate . . . ), ($stop), ($resume) and others similar to HDL simulation environments, which might be used for more advanced user-defined functions. The invention SL language has very high-level, efficient means of abstraction allowing to program very complicated tasks. The interactivity combined with the possibility to compile makes the invention SL language easy to employ in testbench and simulation environments.

The invention SL language provides very high-level extensions for the intelligent testbench development that comprise temporal multiple clock event modeling, modeling interface abstractions and concurrent programming. It has an indisputable distinction from many existing testbench languages due to the fact that it is based on clear functional syntax and semantics. Users easily program functions inside functions, recursions which are simple as “goto” statements, maps and many other complex built-in functions. The language is invented for the purpose of reducing risk in testbench development and creating extremely compact model and test programs. The language functions themselves, can be represented and manipulated as the language data. The language reduces development time and variability in performance along with programming effort and variability of results and manages complexity by means of high order functions and easy emulation of existing verification methodologies.

Behavioral models written in the invention SL language and in accordance with functional design specification are intended for simulation inside the invention environment. The behavioral models describe systems having many functional blocks synchronized by multiple clocks. Different clock edges are allowed. The intelligent testbench written in the invention language is intended for exercising the behavioral, RTL HDL and other language models as well. RTL models are written in HDL in accordance with functional design specification and intended for simulation inside the invention environment through internal programming logical interface. To interface the invention environment with proprietary RTL simulators, callback functions are being used to the HDL objects and events.

The functional verification is performed by mutable state functional models, created in terms of functional mutable objects with constraints. Each functional mutable object is a function having many inside functions that prescribe initial states and constraints. Any constraint function or method always checks if any of its inputs is a valid transaction or a combination of values that could be an integer, list, array, vector, another function, etc. Evaluation of such mutable models into functions provides very high-level verification object abstraction and leads to a significant accelerating simulation runs over pure RTL simulation. Simulation parameters encoded inside the mutable models or defined as outside temporal event expressions impact on simulation runs. There are two types of simulation runs, single-cycle runs and multi-cycle runs. Multi-cycle simulation runs that span several clock cycles supply another sort of abstraction in time domain.

A restricted style or subset of the invention SL language can be synthesizable with transforming programs to the synthesizable netlists in Verilog, VHDL or C/C++. The SL model function connectivity and instantiation is performed as a composition of SL functions. Data path is synthesized or constructed according to specific rules when evaluating functions, their arguments and scheduling primitive and compound functional single-cycle or multi-cycle operations. The restrictions are being applied to the type and the number of function arguments to simplify the synthesis algorithms. Controller is synthesized to enable data path transfers across the clock cycles.

During verification, inputs to the functional models will be induced by the testbenches that try to apply different directed, random or constrained stimuli. Such input stimuli will create many mutations of mutable functional objects with respect to their internally defined constraints. Functional models will mutate through many internal states that in turn will cause many other mutations or state-to-state transfers in other functional objects. In this context, verification task will be defined as verification or validation of an input-output function. The function needs keeping its valid states, specified or defined in a specification, under any mutations. Invalidation or capturing wrong states happens when the input-output function changes its state not in accordance with specification. A capture state can include primitive values or a group of signals packaged into high-level transactions, or temporal parameters, such as events and cycle numbers of different clocks in a design. If a capture state with its vicinity of states gets stored, the bug can be reproduced or traced latter.

The MetaSL environment provides another components to support the intelligent testbench development. It has an embedded built-in simulator that simulates behavioral models by using stimuli generated by test programs and controlled by a multiple clock engine. An analyzer component analyzes the behavioral model and testbench programs to extract information needed for an event scheduler component. An analyzer provides shell and control interaction between user-defined functions and the invention environment. An event scheduler component is an internal environment block that receives control and data temporal dependencies from the interpreter, transforms and supplies the dependency information to the simulator. A multiple clock engine component generates multiple clocks for the simulator based on user-defined clock definitions.

The invention MetaSL environment includes a graphical user interface (GUI) that facilitates the usage of the testbench development and simulation environment. The GUI provides features that visually help users benefit from the characteristics of the invention language even if they are not previously familiar with it. Users gets a higher abstraction level of the modeling and testing process so that verification of their designs can be accelerated. One of the features, visual programming, gives users a source code reuse and guides for better modeling techniques, while the flexibility of developing testbenches is preserved.

The invention MetaSL environment is well suited for assertion checking and the invention SL language ensures an easy way of writing assertions to be validated either by formal verification techniques or by dynamic simulation. Assertions specified in other HVLs or property specification languages (PSLs) can also be verified in MetaSL and the environment can serve as a bridge between formal property verification and dynamic verification. The results provided by formal verification techniques for models specified in the invention SL language and other HVLs or PSLS can be dynamically validated inside the MetaSL environment.

The invention provides means and methodologies for modeling and verification of large systems, for example, a multiprocessor system having several concurrent computing elements with multifunctional queues, memories, buses, arbiters, etc. The graphical MetaSL environment simplifies modeling and verification of the system at instruction cycle levels and provides generic functions used in most microprocessor designs, such as memory, register file, program counter, accumulator, arithmetic and logic unit, etc. The MetaSL GUI ensures easily generating instructions by instantiating these functions whenever needed and calling them at different clock cycles for every instruction. The visual environment prompts designers with relevant selections and instantiates functions automatically. In addition to features provided by the invention language, the invention environment eases the process of writing testbenches. Users may instantiate generic testbench functions such as random and constrained instruction sequence generators, instruction uploading and other modules, and schedule execution of functional checkers. The invention debugging features help display the content of registers and memories, function execution traces and monitor concurrent interfaces.

### BRIEF DESCRIPTION OF DRAWINGS

The above and other objects, advantages and features of the invention will become more apparent when considered with the following specification and accompanying drawings wherein:

FIG. 1 shows a top block diagram of the apparatus comprising a system-level simulation and verification environment in accordance with the invention;

FIG. 2 shows a system comprising one or more functional blocks and temporal behaviors in accordance with the invention;

FIG. 3 shows classifies functions of the invention functional language into verification functions and model functions connected by concurrent interfaces in accordance with the invention;

FIG. 4 shows MetaSL flow comprising main components of the invention environment in accordance with the invention;

FIG. 5 shows a link between a simulator and a proprietary RTL HDL simulator through a shared library interface for verifying model functions modeled in a selected RTL HDL in accordance with the invention;

FIG. 6 shows concurrent interfaces connecting verification functions with model functions and concurrently transfering abstracted signals between the functions in accordance with the invention;

FIG. 7 shows a structural view of a composer for visual construction of functions expressed using the invention functional language and simulated by a simulator along with an intermediate high-level composition flow and its relevant steps in accordance with the invention;

FIG. 8 shows a simulator comprising a compiler for compiling programs written in the invention functional language into another language format, a synthesizer for transforming functions expressed using the invention functional language to synthesizable subsets in a selected RTL HDL, a selected synthesis-ready language, or a selected internal format in accordance with the invention;

FIG. 9 shows a structural-functional view of a functional simulation method to simulate a system comprising functional blocks with one or or more functions expressed in the invention functional language derived from a selected Scheme Language standard in accordance with the invention;

FIG. 10 shows a structural-functional view for a method of generating a mutable function with access functions for a system containing one or more functional blocks using the invention functional language derived from a selected Scheme Language standard in accordance with the invention; and

FIG. 11 shows a structural-functional view for a method of generating functions for a system containing one or more functional blocks using the invention functional language derived from a selected Scheme Language standard in accordance with the invention.

### DETAILED DESCRIPTION OF THE INVENTION

The following description is presently contemplated as the best mode of carrying out the present invention. This description is not to be taken in a limiting sense but is made merely for the purpose of describing the principles of the invention. The scope of the invention should be determined by referring to the future claims.

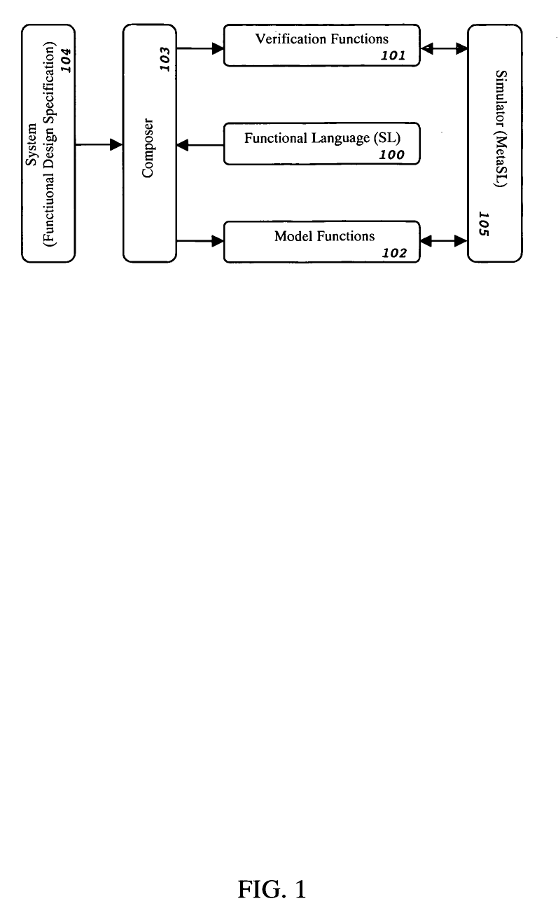

FIG. 1 is a top block diagram of the apparatus comprising a system-level simulation and verification environment according to the invention. The apparatus comprises a simulator (MetaSL) 105, a system (Functional Design Specification) 104, a composer 103, an invention functional language (SL) 100, verification functions 101, and model functions 102. The simulator 105 verifies the system 104 by functional simulation in the system-level simulation and verification environment. The composer 103 provides visual programming features and gives users a source code reuse and guides for better system modeling techniques. The model functions 102 written in SL or another conventional languages model behaviour of the system 104. The verification functions 101 verify that the behavior modeled by the model functions 102 conforms to the functional design specification 104.

The invention provides a method and apparatus to facilitate functional verification of complex reactive systems. The invention is primarily directed to functional language temporal extensions, simulation of functions wrapped in these extensions and an intelligent environment that enables verification of functions with creating referenced functional virtual prototypes in terms of executable specifications for large systems. Therefore, the invention can be used for creating verification sequences or functions for such systems. In addition, the invention can be used for algorithmic modeling, making performance tradeoffs with compiling computationally intensive algorithmic functions inside the environment. In addition, the invention allows for creating customized verification environments.

The preferred embodiment of the invention is optimized for use with Simantix functional language SL that is built around an existing IEEE-1990 Scheme standard. The functional language of the invention ensures rapid creation of virtual prototypes along with verification sequences for large systems. SL prototyping outperforms programming in RTL HDLs, SystemC, conventional C and C++, or other C++ flavors that are all hard to use and labor consuming languages. SL verification sequences and functions created in accordance with the invention can be reused for another implementations of the same functions or complete systems in those languages.

The invention can be used to translate paper written functional and structural specifications of system components along with their temporal behaviors into functional language SL, create verification sequences or tests and produce referenced models as electronic executable specifications to be run in the invention environment. The invention language and tools enable fast and efficient abstraction of complex behavioral interactions between design functions, accelerate creation of functional virtual prototypes, help quickly precharacterize the performance of future implementations and make timely decisions on proper design structures.

The invention is realized in MetaSL and Visual MetaSL system-level environments developed by Simantix Systems, Inc. of Sunnyvale, Calif. The term MetaSL refers to non-visual Simantix language environment and a simulation tool. The term Visual MetaSL refers to Simantix visual system-level development environment based on the MetaSL as an internal engine, or MetaSL GUI. Both realizations are included herein for purposes of example only and is not intended as a limitation upon the scope of the invention.

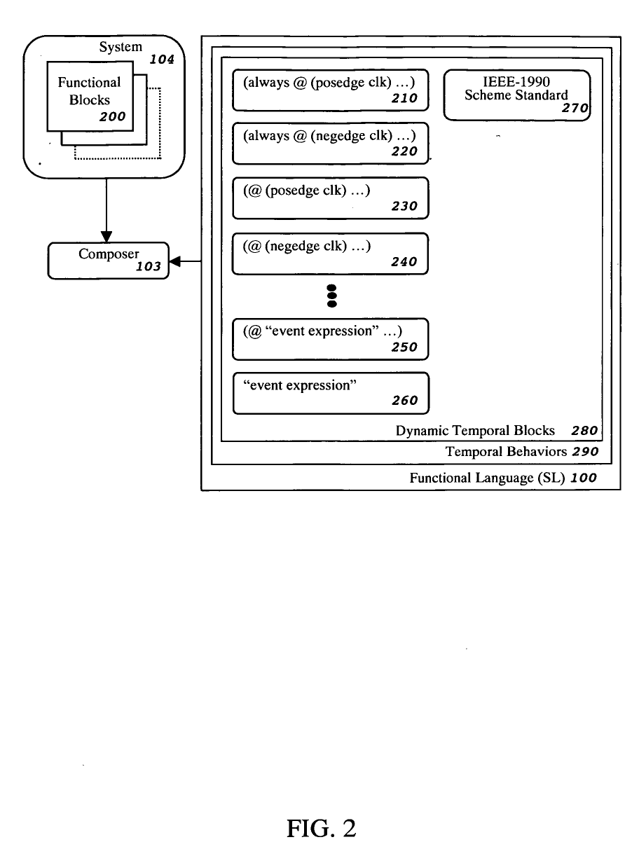

FIG. 2 shows the system 104 comprising one or more functional blocks 200 and temporal behaviors 290. The invention functional language (SL) 100, derived from a selected IEEE-1990 Scheme language standard 270, enables specifications of dynamic temporal blocks 280 and provides syntax extensions for modeling the temporal behaviors 290.

The temporal behaviors 290 modeled in the functional language 100 describe the system 104 having two or more selected functional blocks 200 selectively operated asynchronously, concurrently or synchronized with multiple clocks.

The syntax extensions for modeling the temporal behaviors 290 in the functional language 100 are expressed as the dynamic temporal blocks 280 in accordance with a selected RTL (Register-Transfer Level) HDL (Hardware Description Language) and any dynamic temporal block in the dynamic temporal blocks 280 may selectively have syntax forms similar to the following, (always @ (posedge clk) . . . ) 210, (always @ (negedge clk) . . . ) 220, (@ (posedge clk) . . . ) 230, (@ (negedge clk) . . . ) 240, (@ “event expression” . . . ) 250, “event expression” 260. Dots inside the forms represent any additional arbitrary expressions from the functional language 100. Dots inside the dynamic temporal blocks 280 denote the fact the functional language 100 have many distinct varieties of event functions for dynamic synchronization of the temporal behaviors 290.

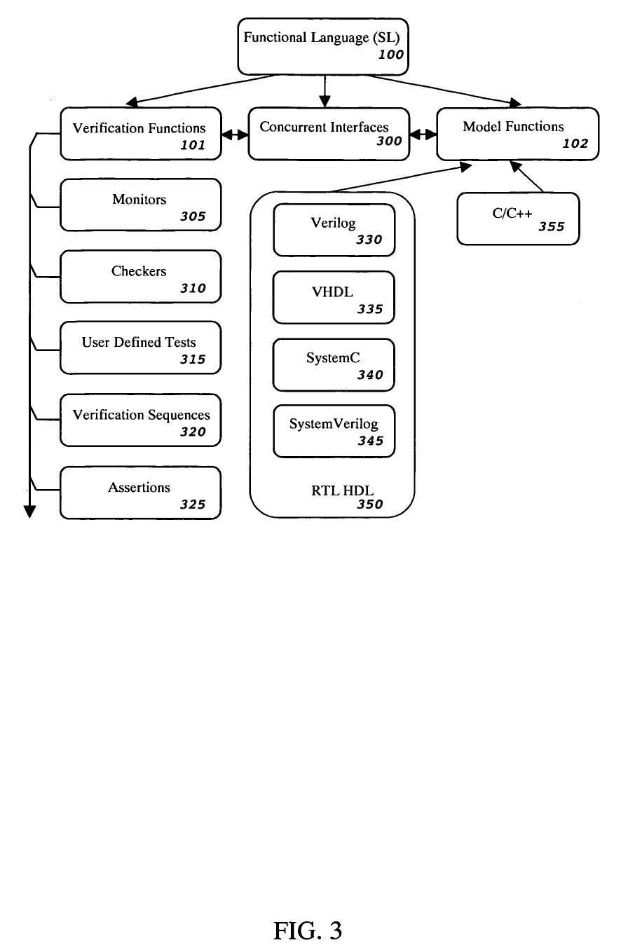

FIG. 3 classifies functions of the invention functional language 100 into verification functions 101 and model functions 102 connected by concurrent interfaces 300. The verification functions 101, which further may comprise one or more monitors 305, checkers 310, user-defined tests 315, verification sequences 320, assertions 325, or any combination of the above, verify the correctness of the functional blocks 200 in the system 104 using the simulator 105.

Functions of the invention functional language 100 include the model functions 102 for modeling the functional blocks 200 in the system 104 to be functionally exercised by the simulator 105. The model functions 102 can also be selectively expressed in a selected RTL HDL 350 or conventional programming language, such as C/C++355. The RTL HDL 350 is selectively Verilog 330, VHDL 335, SystemC 340 or System Verilog 345.

The MetaSL intelligent testbench development environment flow implies multiple clock event modeling, modeling interface abstractions and concurrent programming. The system functional design specification 104 translated into the Simantix functional language SL 100 is verified by dynamic simulation of SL functions. The simulator 105 simulates the SL functions of the functional language 100 in either cycle-based or event driven mode. The SL model functions 102 describe temporal behaviors of the system 104 comprised the functional blocks 200 selectively operable asynchronously, concurrently or synchronized with multiple clocks. Typically, behavioral models in SL describe systems having many functional blocks synchroized by multiple clocks.

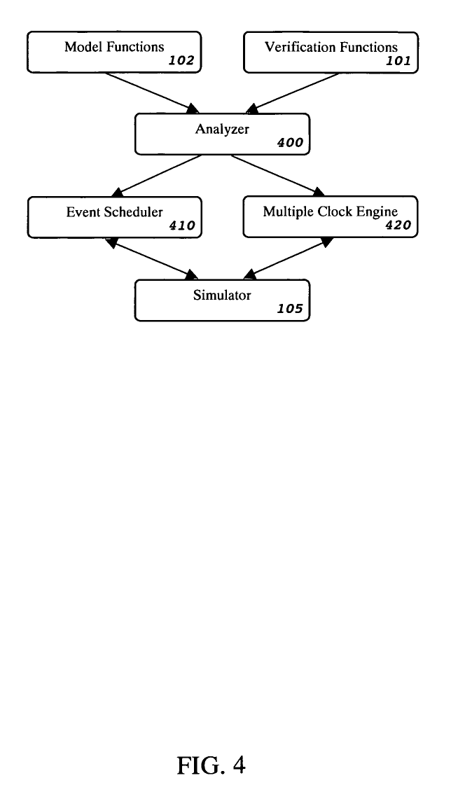

FIG. 4 is a MetaSL flow comprising main components of the invention environment. An SL analyzer 400 analyzes behavioral models in terms of the model functions 102 and testbench programs in terms of the verification functions 101 to extract information to be supplied to an event scheduler 410 and a multiple clock engine 420. The simulator 105 controlled by the multiple clock engine 420 exercises the behavioral models based on stimuli generated by the testbench programs. The event scheduler 410 receives control and data temporal dependency information from the analyzer 400 and propagates it to and from the simulator 105. The multiple clock engine 420 constructs multiple clocks for the simulator 105 based on user-defined clock descriptions using the functional language 100. During simulation the multiple clock engine 420 interacts with the simulator 105. The simulator 105 also performs shell and control interaction functions between user-defined commands and the invention MetaSL environment.

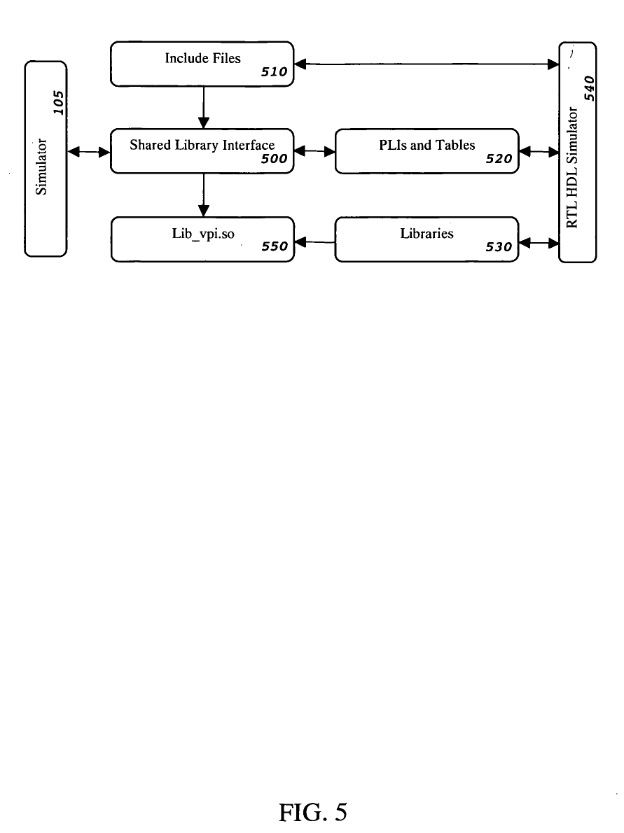

FIG. 5 is a link between the simulator 105 and a proprietary RTL HDL simulator 540 through a shared library interface 500 for verifying model functions modeled in the selected RTL HDL 350. The shared library interface 500 provides the verification functions 101 with either read or write access to registers or wires modeled in the RTL HDL 350 and synchronizes events expressed in the functional language 100 and simulated by simulator 105 with the selected RTL HDL simulator 540. The shared library interface 500 is being further linked with the RTL HDL simulator 540 include files 510, PLIs and Tables 520, and libraries 530. The complete set of files obtained thus far is compiled into a single executable file lib_vpi.so 550. The file lib_vpi.so 550 is further linked with MetaSL environment shared files with producing the simulator 105 enabling to simulate RTL models along with high-level behavioral models written in the functional language 100.

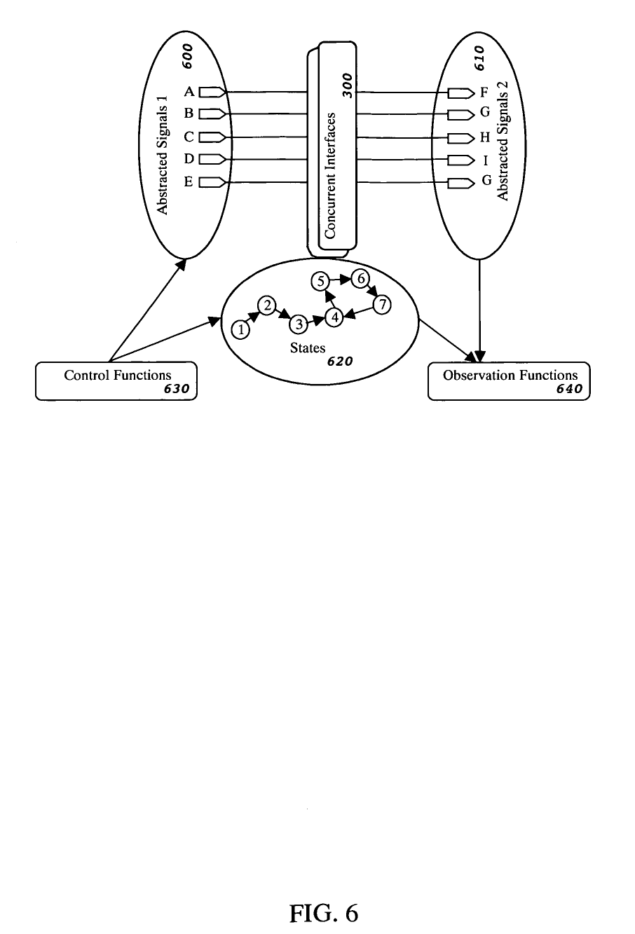

FIG. 6 shows the concurrent interfaces 300 connecting the verification functions 101 with the model functions 102 and concurrently transfering abstracted signals 600, 610 between the functions. The abstracted signals 600 carry values of types expressed as generic or aggregate types of the functional language 100. To control states 620 of the concurrent interfaces 300 the functional language 100 further comprises control functions 630 that drive the abstracted signals 600 with values of types of the functional language 100. To observe the states 620 of the concurrent interfaces 300 the functional language 100 further comprises observation functions 640 that sample the abstracted signals 610 values of types of the functional language 100.

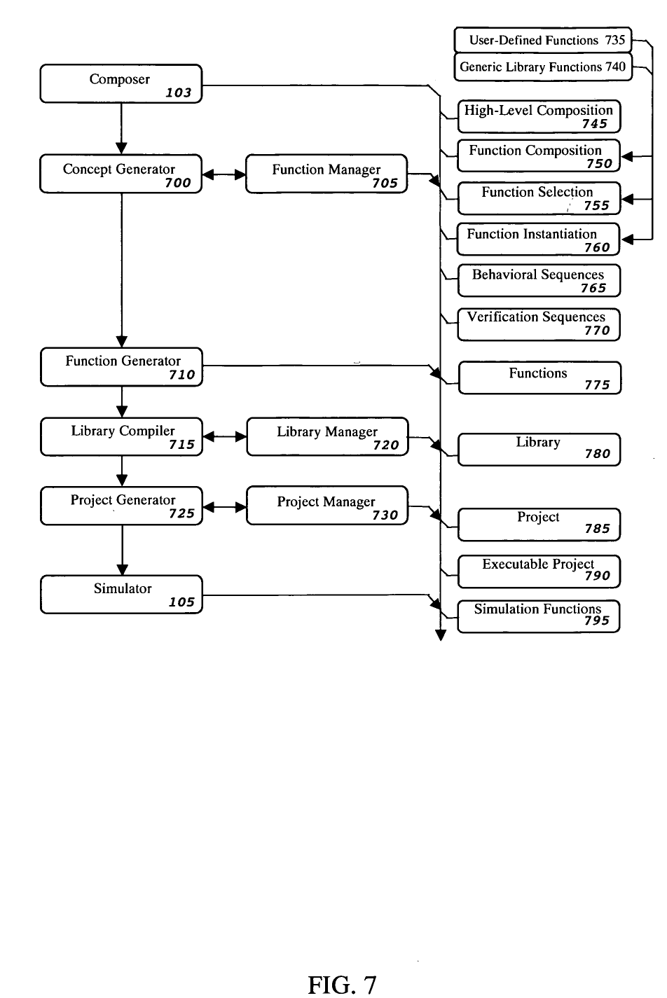

FIG. 7 is a structural view of the composer 103 for visual construction of functions 775 expressed using the functional language 100 and simulated by the simulator 105 along with an intermediate high-level composition 745 flow and its relevant steps.

The composer 103 includes a concept generator 700 with a function manager 705 for constructing behavioral sequences 765 or verification sequences 770, a function generator 710 for generating the functions 775 expressed using the functional language 100 from the behavioral sequences 765 or the verification sequences 770, a library compiler 715 with its library manager 720 for creating a compiled library 780 of the functions 775, and a project generator 725 with its progect manager 730 for creating and managing a project 785 assembled from the single library 780 or a set of libraries. The function manager 705 prompts with relevant function selection 755, function composition 750 and function instantiation 760 using user-defined functions 735 or generic library functions 740 expressed using the functional language 100. The composer 103 and the simulator 105 have special project management functions further comprising project generation functions for abstracting the functions 775 into an executable project 790, project execution functions for executing the project 785 in the system-level simulation and verification environment, and simulation functions 795 for controlling functional simulation of the system 104.

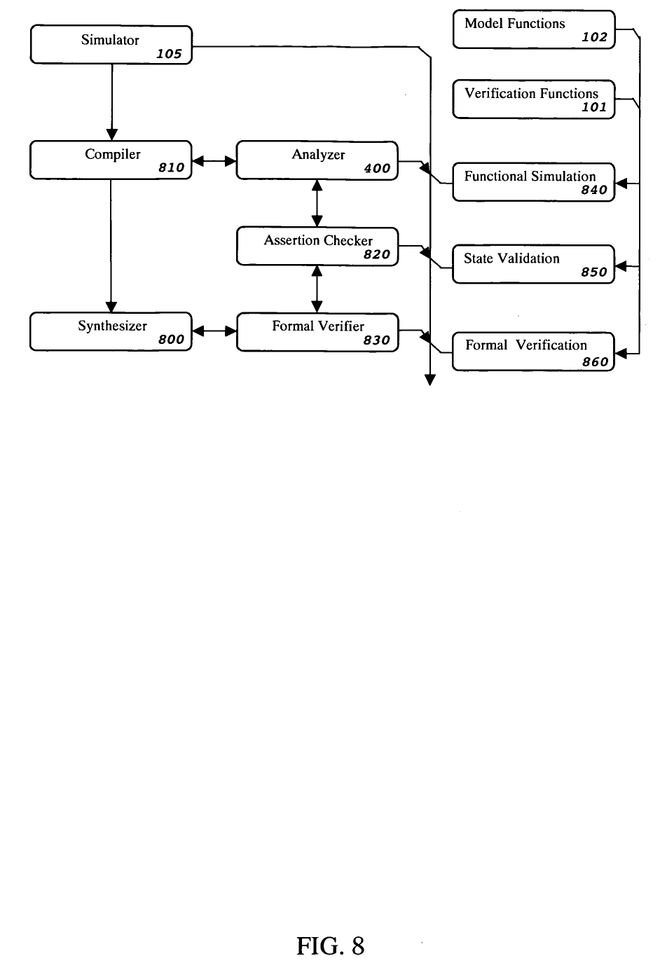

FIG. 8 shows the simulator 105 comprising a compiler 810 for compiling programs written in the functional language 100 into another language format, a synthesizer 800 for transforming the functions 775 expressed using the functional language 100 to synthesizable subsets in the selected RTL HDL 350, a selected synthesis-ready language, or a selected internal format.

The compiler 810 interacts with the analyzer 400 that exchanges data with an assertion checker 820 and enables a functional simulation 840. The synthesizer 800 interacts with a formal verifier 830 for generating an additional state information about the model functions 102. The assertion checker 820 provides a state validation 850 either by the functional simulation 840 using the analyzer 400 and processing the verification functions 101 or by a selected formal verification 860 using the formal verifier 830. The formal verifier 830 bridges the functional simulation 840 with formal verification techniques for formally verifying the model functions 102.

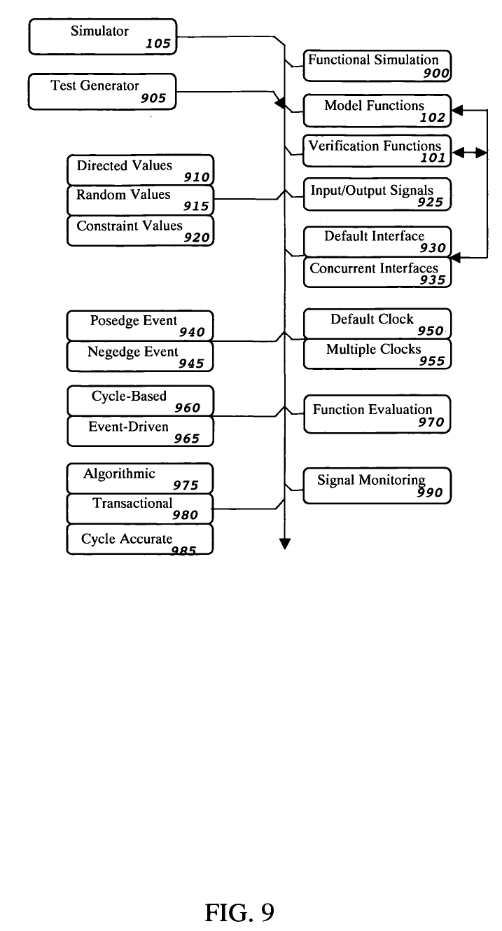

FIG. 9 shows a structural-functional view of a functional simulation 900 method to simulate the system 104 comprising the functional blocks 200 with one or or more functions expressed in the invention functional language 100 derived from a selected Scheme Language standard. The system 104 is being verified by the functional simulation 900 using a test generator 905. The functional language 100 provides syntax extensions for modeling temporal behaviors. One or more of the functions are being designated as model functions 102 for modeling the functional blocks and as verification functions 101 for verifying the functional blocks by defining a default concurrent interface 930 or defining concurrent interfaces 935 for monitoring interconnections between the functional blocks and using a default clock 950 or multiple clocks 955 descriptions.

The functional simulation 900 of the functions takes place concurrently or pseudo-concurrently using the simulator 105. When concurrently simulating the functions, the simulator 105 uses multithreading. When pseudo-concurrently simulating the functions the simulator 105 uses scheduling mechanisms. The simulator 105 during a function evaluation 970 evaluates the functions on a positive edge 940 or a negative edge 945 of the default clock 950 or the multiple clocks 955 either in a cycle-based 960 mode or an event-driven 965 mode.

System verification requires an optional step of connecting the verification functions 101 to the model functions 102, an optional step of backward connecting the model functions 102 to the verification functions 101 for generating dynamic verification tests, a specification of input and output signals 925 for the verification functions 101 and the model functions 102. The verification functions 101 or the mode functions 102 drive their output signals through the concurrent interfaces 935 using selectively random values 915, directed values 910 or constraint values 920 obtained from a test generator 905 and sample their input signals driven through the concurrent interfaces 935 to obtain values for further comparison with their expected values by a checker or a formal verifier. The concurrent interfaces 935 act as a concurrent procedure enabling visibility into intermediate state variable values in the system 104. A signal monitoring 990 values on the concurrent interfaces 935 happens selectively on algorithmic 975, transactional 980 or cycle accurate 985 abstraction levels.

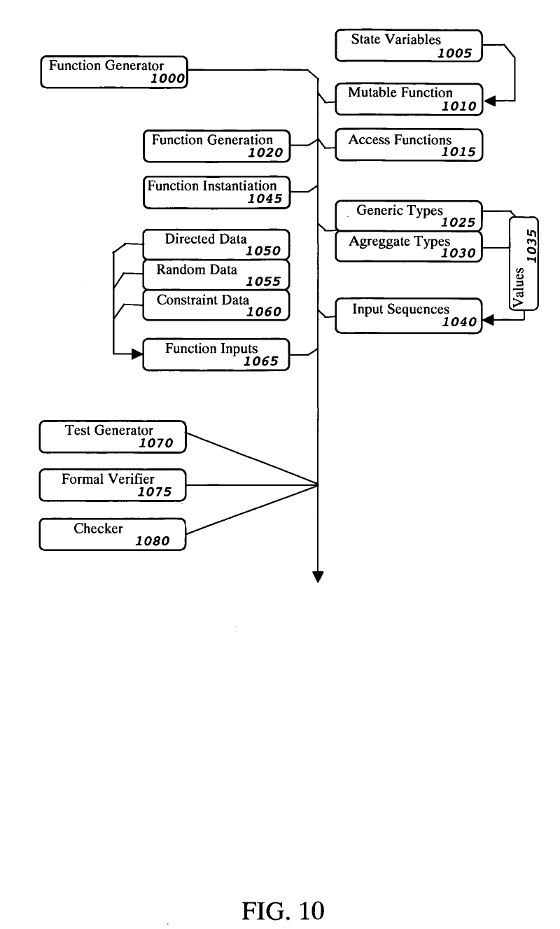

FIG. 10 is a structural-functional view for a method of generating a mutable function with access functions for the system 104 containing one or more of the functional blocks 200 using the invention functional language 100 derived from a selected Scheme Language standard.

The functional language 100 provides syntax extensions for modeling temporal behaviors. A mutable function 1010 with internal modifiable state variables 1005 is being specified and automatically generated along with its access functions 1015 by using a function generator 1000 in a function generation 1020 phase. The mutable function is being further instantiated during a function instantiation phase 1045 to use in functional simulation of the system 104 by the simulator 105.

One of the mutable functions generated and instantiated thus far can be optionally instantiated and operated as a universal test generator 1070 for inducing input sequences 1040 with values 1035 of either generic types 1025 or aggregate types 1030 of the invention functional language for the state variables 1005. The values 1035 of the input sequences 1040 are selectively random data 1055, directed data 1050 or constraint data 1060 generated by this mutable function at its function inputs 1065 during functional simulation. Same or another mutable function can be optionally instantiated and operated as either a formal verifier 1075 or a universal checker 1080 for verifying values or value sequences for the state variables 1005 with their expected values.

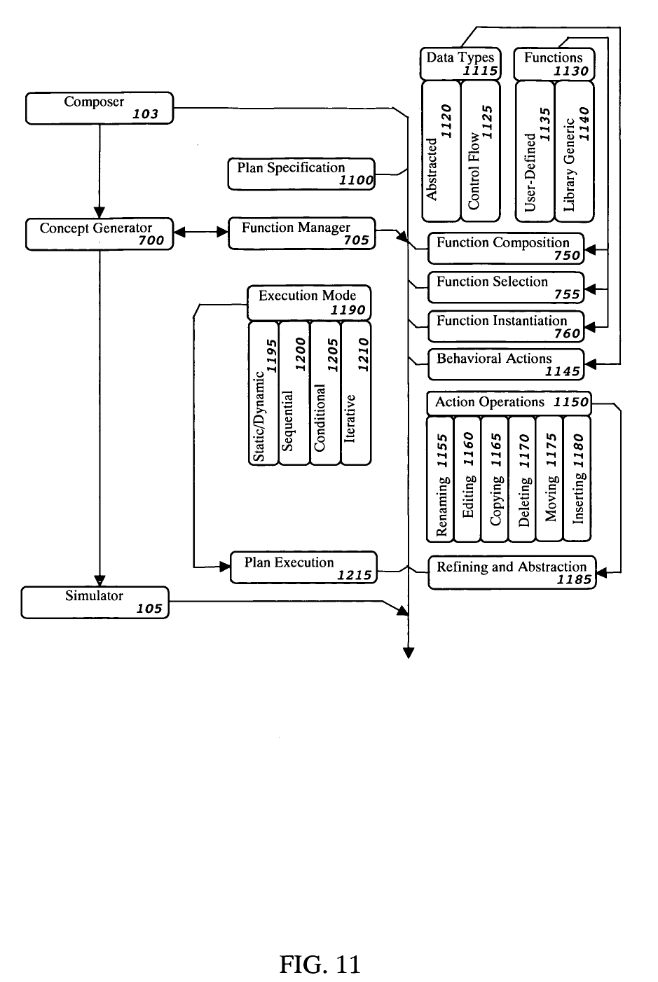

FIG. 11 shows a structural-functional view for a method of generating functions for the system 104 containing one or more of the functional blocks 200 using the invention functional language 100 derived from a selected Scheme Language standard.

The functional language 100 provides syntax extensions for modeling temporal behaviors. In a plan specifiation 1100 phase the composer 103 using a concept generator 700 enables a plan specification in terms of a high-level composition to be executed by the simulator 105 for describing behavioral actions 1145 at a conceptual level higher than the level of the functional language 100. The plan composed thus far is being further elaborated into functions expressed using the functional language 100 using a function manager 705 and executed during a plan execution 1215 phase by the simulator 105.

In a refining and abstraction 1185 phase the behavioral actions 1145 are being assigned predefined abstracted 1120 data types 1115 along with a control flow 1125 information for their selectively temporal execution, conditional execution 1205 or iterative execution 1210 by the simulator 105. The concept generator 700 further selectively instantiates during a function instantiation 760, composes during a function composition 750 or selects during a function selection 755 user-defined 1135 or library generic 1140 functions 1130 to subsequent function generation for the system 104.

Refining the plan occur by selective action operations 1150 such as editing 1160, renaming 1155, copying 1165, deleting 1170, moving 1175 or inserting 1180 the behavioral actions 1145. The plan is further being abstracted into a function of specific type, and loaded or compiled for further execution during the plan execution 1215 by the simulator 105. The simulator 105 executes the behavioral actions 1145 of the plan in static or dynamic 1195 mode.

Having thus described presently preferred embodiments of the present invention, it can now be appreciated that the objectives of the invention have been fully achieved. And it will be understood by those skilled in the art that many changes in construction and circuitry, and widely differing embodiments and applications of the invention will suggest themselves without departing from the spirit and scope of the present invention. The disclosures and the description herein are intended to be illustrative and are not in any sense limitation of the invention, more preferably defined in scope by the following claims.

1. An apparatus for functional simulation and verification of complex temporal reactive systems in a system-level simulation and verification environment, the system containing one or more functional blocks; said apparatus comprising:
a functional language derived from a selected Scheme Language standard, the functional language provides syntax extensions for modeling temporal behaviors; and
a simulator for simulating functions expressed in said functional language, wherein said simulator verifies said system by said functional simulation in said system-level simulation and verification environment.

2. The apparatus of claim 1, wherein said temporal behavior modeled in said functional language describes said system having two or more selected functional blocks selectively operated asynchronously, concurrently or synchronized with multiple clocks.

3. The apparatus of claim 1, wherein said syntax extensions for modeling said temporal behaviors in said functional language are further expressed as dynamic temporal blocks in accordance with a selected RTL (Register-Transfer Level) HDL (Hardware Description Language).

4. The apparatus of claim 3, wherein said selected RTL HDL is selectively Verilog, VHDL, SystemC or System Verilog.

5. The apparatus of claim 3, wherein said dynamic temporal block is expressed as “always @” using said selected RTL HDL.

6. The apparatus of claim 3, wherein said dynamic temporal block is expressed as “@” using said selected RTL HDL.

7. The apparatus of claim 3, wherein said dynamic temporal block is expressed as an event expression using said selected RTL HDL.

8. The apparatus of claim 1, wherein said function further comprises verification functions for verifying the correctness of selected functional blocks in said system using said simulator.

9. The apparatus of claim 8, wherein said verification function further includes verification sequences for verifying said selected functional blocks in said system.

10. The apparatus of claim 8, wherein said verification function further comprises one or more monitors, checkers, user-defined tests, assertions, or any combination thereof.

11. The apparatus of claim 1, wherein said function further comprises model functions for modeling selected functional blocks in said system to be functionally exercised by said simulator.

12. The apparatus of claim 11, wherein said model function is selectively expressed in said functional language, a selected RTL HDL, or a selected conventional programming language, such as C/C++.

13. The apparatus of claim 12, wherein said selected RTL HDL is selectively Verilog, VHDL, SystemC or System Verilog.

14. The apparatus of claim 1, further comprising a language analyzer developed to interpret either said model functions or said verification functions.

15. The apparatus of claim 14, wherein said analyzer further comprises a compiler for compiling said model functions or said verification functions.

16. The apparatus of claim 14, further comprising an event scheduler for receiving control and data temporal dependency information from said language analyzer.

17. The apparatus of claim 14, wherein said event scheduler propagates said control and said data temporal dependency information to and from said simulator.

18. The apparatus of claim 14, further comprising a multiple clock engine for constructing multiple clocks for said simulator based on user-defined clock descriptions using said functional language.

19. The apparatus of claim 18, wherein said multiple clock engine interacts with said simulator.

20. The apparatus of claim 1, wherein said simulator simulates said functions expressed using said functional language functions in either cycle-based or event driven mode.

21. The apparatus of claim 1, wherein said simulator links to a selected RTL HDL simulator through a shared library interface for verifying model functions modeled in RTL HDL.

22. The apparatus of claim 21, wherein said shared library interface further provides said verification functions with either read or write access to model registers or wires in said RTL HDL.

23. The apparatus of claim 21, wherein said shared library interface further synchronizes events expressed in said functional language and simulated by said simulator with said selected RTL HDL simulator.

24. The apparatus of claim 1, further comprising concurrent interfaces for connecting verification functions with model functions.

25. The apparatus of claim 24, wherein said concurrent interfaces concurrently transfer abstracted signals between said model functions and said verification functions.

26. The apparatus of claim 24, wherein said abstracted signals carry values of types expressed as generic or aggregate types of said functional language.

27. The apparatus of claim 1, wherein said functional language further comprises control functions to control states of concurrent interfaces.

28. The apparatus of claim 27, wherein said control functions drive abstracted signals with values of types of said functional language.

29. The apparatus of claim 1, wherein said functional language further comprises observation functions to observe states of concurrent interfaces.

30. The apparatus of claim 29, wherein said observation functions sample abstracted signal values of types of said functional language.

31. The apparatus of claim 1, wherein said simulator further comprises a synthesizer for transforming said functions expressed using said functional language to synthesizable subsets in a selected RTL HDL, a selected synthesis-ready language, or a selected internal format.

32. The apparatus of claim 1, wherein said simulator further comprises an assertion checker for validating states of said functions either by said functional simulation or by selected formal verification techniques.

33. The apparatus of claim 1, wherein said simulator further comprises a formal verifier that bridges said functional simulation with formal verification techniques for formally verifying model functions expressed using said functional language.

34. The apparatus of claim 1, further comprising a composer for visually constructing said functions using said functional language.

35. The apparatus of claim 34, wherein said composer further comprises a concept generator for constructing behavioral or verification sequences.

36. The apparatus of claim 35, wherein said concept generator further comprises a function generator for generating said functions expressed using said functional language from said behavioral or verification sequences.

37. The apparatus of claim 34, wherein said composer further comprises a function manager for prompting with relevant selection of said functions expressed using said functional language.

38. The apparatus of claim 34, wherein said composer instantiates user-defined or generic library functions from said functional language.

39. The apparatus of claim 1, wherein said simulator further comprises project management functions for managing a project assembled from said functions compiled into libraries.

40. The apparatus of claim 39, wherein said project management functions further comprise project generation functions for abstracting said functions defined using said functional language into an executable project.

41. The apparatus of claim 40, wherein said project management functions further comprise project execution functions for executing said project in said system-level simulation and verification environment.

42. The apparatus of claim 1, wherein said functional language further comprises simulation functions for controlling said functional simulation of said system.

43. A method for functional simulation of a system comprising functional blocks with one or more functions expressed in a functional language derived from a selected Scheme Language standard, the functional language provides syntax extensions for modeling temporal behaviors; said method comprising the steps of:
designating one or more said functions as a model function for modeling said functional blocks;
designating one or more said functions as a verification function for verifying said functional blocks;
using a default concurrent interface or defining concurrent interfaces for monitoring interconnections between said functional blocks; and
using a default clock or defining multiple clocks to verify said system using said functional simulation.

44. The method of claim 43, further comprising an optional step of connecting said verification function to said model function in said system.

45. The method of claim 43, further comprising an optional step of backward connecting said model function to said verification function for generating dynamic verification tests in said system.

46. The method of claim 43, further comprising a specification of input and output signals for said verification function in said system.

47. The method of claim 43, further comprising a specification of input and output signals for said model function in said system.

48. The method of claim 43, wherein said functional simulation of said functions in said system takes place concurrently or pseudo-concurrently using a simulator.

49. The method of claim 48, wherein said simulator simulates said functions concurrently using multithreading or schedules said functions to simulate them in said pseudo-concurrent mode.

50. The method of claim 48, wherein in said functional simulation said simulator evaluates said functions on positive or negative edges of said default clock or said multiple clocks either in cycle-based mode or event-driven mode.

51. The method of claim 43, wherein either said verification functions or said model functions drive their output signals through said concurrent interface using selectively random, directed or constraint values obtained from a test generator.

52. The method of claim 43, wherein either said verification functions or said model functions sample their input signals driven through said concurrent interface to obtain values for further comparison with their expected values by a checker or a formal verifier.

53. The method of claim 43, wherein said concurrent interface acts as a concurrent procedure enabling visibility into intermediate state variable values in said system.

54. The method of claim 43, further comprising a step of monitoring signal values of said concurrent interface selectively on algorithmic, transactional or cycle accurate abstraction levels.

55. A method of generating a mutable function with access functions for a system containing one or more functional blocks using a functional language derived from a selected Scheme Language standard, the functional language provides syntax extensions for modeling temporal behaviors; said method comprising the steps of:
specifying said mutable function with internal modifiable state variables; and
automatically generating said mutable function with said access functions by using a function generator wherein said mutable function can be instantiated to be used in functional simulation of said system by a simulator.

56. The method of claim 55, wherein said mutable function can be optionally instantiated and operated as a universal test generator for inducing input sequences with values of either generic or aggregate types of said functional language for said state variables.

57. The method of claim 56, wherein said values of said input sequences are selectively random, directed or constraint data generated by said mutable function during said functional simulation.

58. The method of claim 55, wherein said mutable function can be optionally instantiated and operated as either a formal verifier or a universal checker for verifying value sequences on said state variables with their expected values.

59. A method of generating functions for a system containing one or more functional blocks using a functional language derived from a selected Scheme Language standard, the functional language provides syntax extensions for modeling temporal behaviors; said method comprising the steps of:
specifying a plan using a concept generator; and
elaborating said plan into said functions expressed using said functional language wherein said plan can be executed by a simulator in verifying said system.

60. The method of claim 59, wherein said plan is a high-level composition to be executed by said simulator for describing behavioral actions at a conceptual level higher than the level of said functional language.

61. The method of claim 60, wherein said simulator further comprises executing behavioral actions of said plan statically or dynamically.

62. The method of claim 60, wherein said behavioral actions include a predefined abstracted type.

63. The method of claim 60, further comprising a step of assigning a control flow information to said behavioral actions for their selectively temporal, conditional or iterative execution by said simulator.

64. The method of claim 59, wherein said concept generator further selectively instantiates, composes or selects user-defined or generic functions for generating said functions for said system.

65. The method of claim 59, further comprising a step of refining said plan by selective editing, renaming, copying, deleting, moving or inserting behavioral actions in said plan for said system.

66. The method of claim 59, further comprising a step of abstracting said plan into a function of specific type.

67. The method of claim 59, further comprising a step of loading or compiling said plan for further execution using said simulator.
